(19) United States
(12) Patent Application Publication
(10) Pub. No.: US 2011/0062231 A1
(43) Pub. Date: Mar. 17, 2011

(54) AUTOMATIC TELLER APPARATUS AND TICKET ORDER PROCESSING METHOD THEREOF

(76) Inventor: Shun-Ho WANG, Taipei City (TW)

(21) Appl. No.: 12/559,936

(22) Filed: Sep. 15, 2009

(51) Int. Cl. G07F 19/00

(52) U.S. Cl. 235/379

(57) ABSTRACT

A ticket order processing method used in an automatic teller apparatus includes an identifying process, an ordering process and a communicating process. The identifying process identifies a user according to a financial identification element. The ordering process provides one or more ticket-ordering interfaces for the user so as to create electronic ticket information, provides an input interface for the user to input electronic communication data, and deducts money from an account corresponding to the financial identification element. The communicating process transmits the electronic ticket information and the electronic communication data to an external server. In addition, an automatic teller apparatus performing the ticket order processing method is also disclosed.

### BACKGROUND OF THE INVENTION

1. Field of Invention

The present invention relates to an automatic teller apparatus and, in particular, to an automatic teller apparatus with ticket ordering function and a ticket order processing method thereof.

2. Related Art

It is quite normal to buy a ticket in advance for many activities such as joining an entertainment activity or taking a train. The ticket for sale can be a ball game ticket, a movie ticket or a train ticket.

In the old days, the buyer has to go to the booking office, and then purchases the tickets from the booking clerk. For example, the train tickets are sold at the booking office in the train station, the movie tickets are sold at the booking office in the theater, and the performance tickets are sold at the booking office in the performance theater. The buyer must tell the booking clerk what kind ticket is needed and pay the money for the ticket, and then he/she can retrieve the ticket. However, the conventional way for selling ticket by booking clerk is very slow, so that the buyers have to stand in the line and wait for a long time for buying the tickets.

In order to improve the efficiency for buying or ordering tickets, the automatic ticket issuing machines are installed at the above-mentioned places for the users. However, no matter the tickets are sold in the booking offices or automatic ticket issuing machines, the users must go to the train station, movie theater or performance theater to buy and get the tickets. This is really causing inconvenience of the users.

Recently, the vendors have tried to sell the tickets through Internet, so that the users can order and buy the tickets from their websites. However, to buy the tickets through Internet, the users usually pay the money by credit card or transferring accounts on line, which are not really secure because the credit card or personal information may be stolen. Moreover, the tickets bought through Internet can not be sent to the consumers immediately. Normally, the consumers have to go to the designated place to get the tickets or wait for the mailed tickets, which both cause inconvenience of the users.

### SUMMARY OF THE INVENTION

In view of the foregoing, the present invention is to provide an automatic teller apparatus, which can sell electronic tickets, and a ticket order processing method thereof.

To achieve the above, the present invention discloses a ticket order processing method used in an automatic teller apparatus, which includes an identifying process, an ordering process and a communicating process. The identifying process identifies a user according to a financial identification element. The ordering process provides one or more ticket-ordering interfaces for the user so as to create electronic ticket information, provides an input interface for the user to input electronic communication data, and deducts money from an account corresponding to the financial identification element. The communicating process transmits the electronic ticket information and the electronic communication data to an external server.

In addition, the present invention also discloses an automatic teller apparatus, which includes an identification module, an ordering module and a communicating module. The identification module identifies a user according to a financial identification element. The ordering module provides one or more ticket-ordering interfaces for the user to create electronic ticket information, provides an input interface for the user to input electronic communication data, and deducts money from an account corresponding to the financial identification element. The communicating module transmits the electronic ticket information and the electronic communication data to an external server.

In an aspect of the present invention, the external server creates an electronic ticket according to the electronic ticket information and then transmits the electronic ticket to a portable electronic device according to the electronic communication data.

In an aspect of the present invention, the electronic communication data designates where the electronic ticket should be transmit to. For example, the electronic communication data can be a phone number of a portable communication device, so that the electronic ticket will be transmitted to the portable communication device corresponding to the phone number. Alternatively, the electronic communication data can be an email address, so that the electronic ticket will be transmitted to the email box corresponding to the email address.

In an aspect of the present invention, the electronic ticket is a traffic ticket or an entertainment ticket.

In an aspect of the present invention, the electronic ticket includes an electronic pattern. For example, the electronic ticket may include a two-dimensional bar code generated according to the electronic ticket information.

In an aspect of the present invention, the electronic ticket information includes ticket type data and price data, which includes the price for buying the ticket, and the ordering process/module deducts money from the account corresponding to the financial identification element according to the price data.

In an aspect of the present invention, the ordering process/module further transfers the money, which is deducted from the account corresponding to the financial identification element, to a receiving account.

The ticket type data includes a location column, a name column, a time column, an origin-destination column, a seat column, a vehicle type column, or their combinations.

In an aspect of the present invention, the ordering process/module checks whether the account corresponding to the financial identification element has enough money or not.

In the system including the automatic teller apparatus and the external server, the automatic teller apparatus provides the mechanisms for ordering the ticket and paying for it, and the external server responses for transmitting the electronic ticket to the destination designated by the electronic communication data.

As mentioned above, the present invention utilizes the automatic teller apparatuses, which are available everywhere, to solve the inconvenience for the user to buy various kind of tickets. In addition, since the ticket order is performed through the automatic teller apparatuses, the personal information may not be stolen, and the money for the ticket can be directly deducted from the account corresponding to the financial identification element. This further enhances the convenience for the user to order the tickets through automatic teller apparatuses. Moreover, according to the present invention, the user may input electronic communication data, such as his/her mobile phone number or email address, so that the electronic ticket can be transmitted to the mobile phone or email box of the user. Then, the user can use the received electronic ticket directly, thereby greatly enhancing the convenience of ordering tickets.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a system structure of an automatic teller apparatus according to a preferred embodiment of the present invention;

FIGS. 2A and 2B are schematic diagrams showing another system structure of the automatic teller apparatus according to the preferred embodiment of the present invention;

FIG. 3 is a flow chart showing a ticket order processing method used in the automatic teller apparatus according to the preferred embodiment of the present invention;

FIGS. 4A and 4B are flow charts showing different aspects of the ticket order processing method used in the automatic teller apparatus according to the preferred embodiment of the present invention;

FIG. 5 is a flow chart showing the implementation of the ticket order processing method used in the automatic teller apparatus according to the preferred embodiment of the present invention;

FIGS. 6A and 6E are schematic views of the screens displayed on the automatic teller apparatus in different steps;

FIG. 7 is a flow chart showing the implementation of the ticket order processing method used in the automatic teller apparatus according to the preferred embodiment of the present invention;

FIG. 8 is a block diagram showing the automatic teller apparatus according to the preferred embodiment of the present invention; and

FIG. 9 is a block diagram showing another automatic teller apparatus according to the preferred embodiment of the present invention.

### DETAILED DESCRIPTION OF THE INVENTION

The present invention will be apparent from the following detailed description, which proceeds with reference to the accompanying drawings, wherein the same references relate to the same elements.

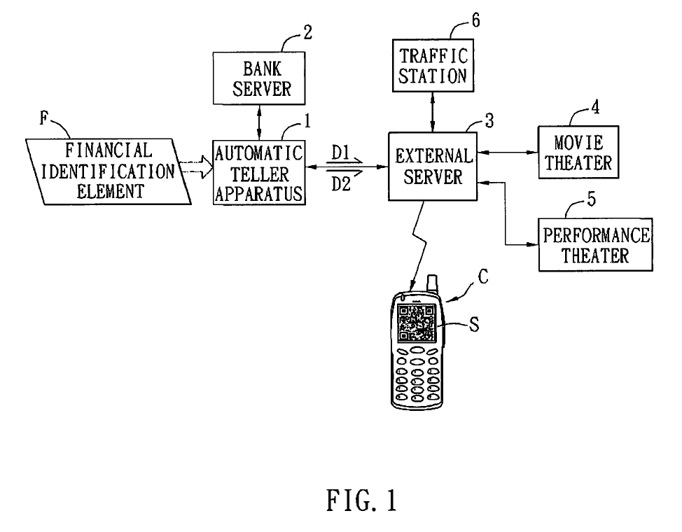

With reference to FIG. 1, an automatic teller apparatus 1 is linked to a bank server 2 and an external server 3. After the automatic teller apparatus 1 identifies a user through a financial identification element F, the user is authorized to operate the automatic teller apparatus 1 to, for example, withdraw money, transfer money, pay fees, or enquire the balance of the account. The automatic teller apparatus 1 and the bank server 2 belong to the same bank, so that the automatic teller apparatus 1 can check, through the bank server 2, whether the account of the user is enough for the withdrawal, transfer, payment, or deduction.

In the embodiment, the automatic teller apparatus 1 can not only provide the general financial services, but also offer the service for ordering electronic tickets. In more details, the user can operate the automatic teller apparatus 1 to select the ticket, pay the money for it, and input electronic communication data D2 for receiving the electronic ticket. The automatic teller apparatus 1 can create electronic ticket information D1 accordingly, and then transmit the electronic ticket information D1 and the electronic communication data D2 to the external server 3. After that, the external server 3 can transmit the electronic ticket to a portable electronic device C corresponding to the electronic communication data D2. In this case, the user can select the ticket and pay the money for it through the automatic teller apparatus 1, and then receive the electronic ticket through his/her portable electronic device C such as a mobile phone or a digital computing device with the Internet communication function.

For example, the automatic teller apparatus 1 can be an automatic teller machine (ATM) or an automatic deposit machine (ADM), and the financial identification element F can be an ATM card, a debit card or a credit card

The ticket can be paid through the bank server 2 to deduct the account corresponding to the financial identification element F. For example, the financial identification element F can be issued by the bank, who owns the automatic teller apparatus 1, so that the bank server 2 can deduct money from the account corresponding to the financial identification element F and then transfer the money to the receiving account. If the financial identification element F is issued by another bank, the bank server 2 must request that bank to deduct money from the account corresponding to the financial identification element F and then transfer the money to the receiving account.

The electronic communication data D2 can be a mobile phone number or an e-mail address. If the electronic communication data D2 is a mobile phone number, the external server 3 can transmit the electronic ticket to the mobile phone corresponding to the phone number through the MMS (multi-media Message Service) of the telecommunication system. If the electronic communication data D2 is an e-mail address, the external server 3 can transmit the electronic ticket to the email box corresponding to the email address through Internet. In this case, the user may operate any digital computing device with Internet communication function to retrieve the electronic ticket from the email box.

The electronic ticket may include an electronic pattern, which is generated according to the electronic ticket information D1. For example, the electronic pattern may include a two-dimensional bar code S, such as a QR-code (Quick Response code) as shown in FIG. 1. The display of the portable electronic device C such as a mobile phone shows the two-dimensional bar code S.

The two-dimensional bar code is a black-and-white pattern, and is composed of dots and bars. In general, the two-dimensional bar code may contain the word, picture and sound information, so that it is superior to the traditional one-dimensional bar code and has the advantages of large capacity, high reliability and improved security.

In addition, the electronic ticket can be an electronic text ticket, which contains text information. Of course, the electronic ticket may contain both the pattern information and text information.

The external server 3 is linked to the servers of the service suppliers, such as a movie theater 4, a performance theater 5, a traffic station 6, an exhibition center (not shown) and etc. In the embodiment, the performance theater 5 is, for example, an opera theater or a music theater, and the traffic station 6 is, for example, a train station or a bus station. The tickets sold through the automatic teller apparatus 1 are provided by the external server 3.

The electronic ticket can be, for example, a traffic ticket (e.g. the train or bus ticket) or an entertainment ticket (e.g. the movie, opera, ball game or exhibition ticket). The user can use the electronic ticket to take train or bus, or to enter the movie or opera theater.

As mentioned above, since the automatic teller apparatuses 1 are available in many places, the users can operate them to conveniently order various kinds of tickets. In addition, since the ticket order is performed through the automatic teller apparatuses 1, the personal information may not be stolen, and the money for the ticket can be directly deducted from the account corresponding to the financial identification element F. This further enhances the convenience for the user to order the tickets. Moreover, the user may input electronic communication data, such as his/her mobile phone number or email address, so that the electronic ticket can be transmitted to the mobile phone or email box. Then, the user can use the received electronic ticket, thereby greatly enhancing the convenience of ordering tickets.

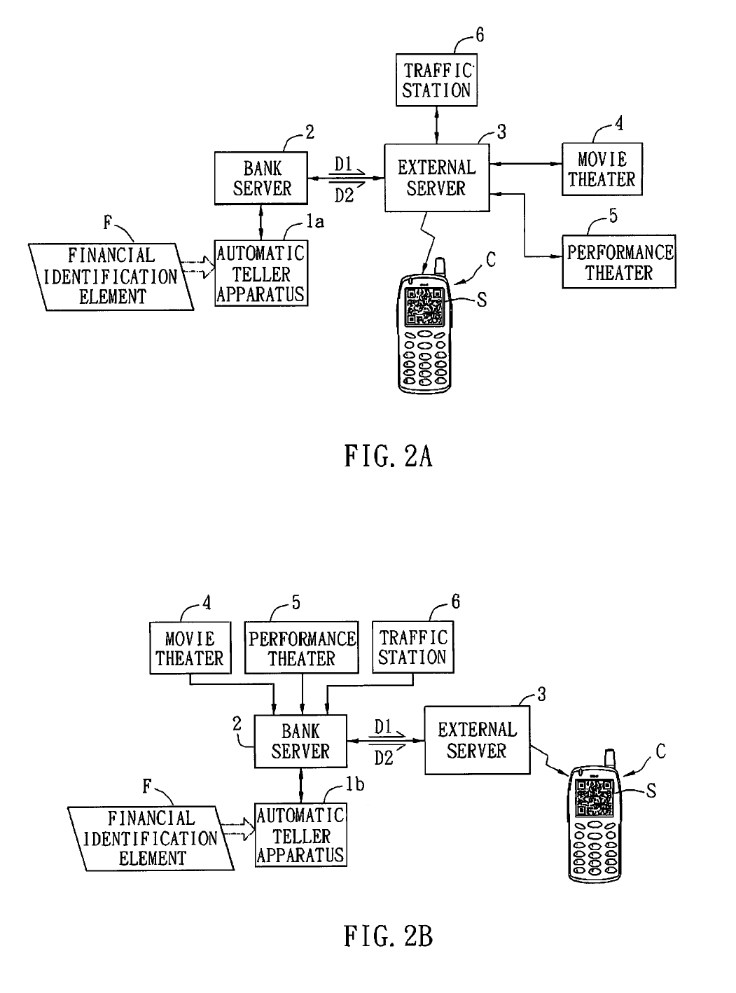

As shown in FIG. 2A, since the bank usually has many automatic teller apparatuses, for the sake of reducing hardware cost, the automatic teller apparatus 1a is connected to the external server 3 through the bank server 2. Thus, the automatic teller apparatus 1a can transmit the electronic ticket information D1 and the electronic communication data D2 to the external server 3 through the bank server 2. The provided services and processing flows of the automatic teller apparatus 1a are similar to those of the automatic teller apparatus 1, so the detailed description thereof will be omitted.

In addition, as shown in FIG. 2B, the automatic teller apparatus 1b is linked to the external server 3 through the bank server 2, so that the bank server 2 is directly linked to the external server 3 such as a movie theater 4, a performance theater 5, a traffic station 6, an exhibition center (not shown) and etc, which need ticket for entering permission. Then, the automatic teller apparatus 1b transmits the electronic ticket information D1 and the electronic communication data D2 to the external server 3 through the bank server 2. The contents of the available tickets, which can be sold through the automatic teller apparatus 1b, are provided by the bank server 2. The services and processing steps provided by the automatic teller apparatus 1b are similar to those of the above-mentioned automatic teller apparatus 1, so the detailed description thereof will be omitted.

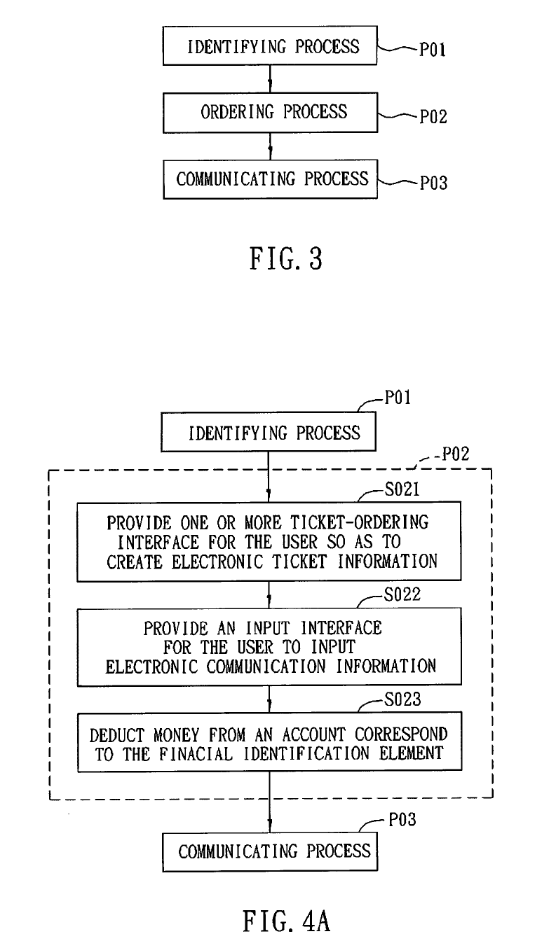

Referring to FIG. 3, a ticket order processing method, which can be used in the above-mentioned or following automatic teller apparatus, includes an identifying process P01, an ordering process P02 and a communicating process P03.

The identifying process P01 identifies a user according to a financial identification element F. In more details, the automatic teller apparatus reads the financial identification element F to retrieve the account information through the bank server 2 so as to identify the user. The financial identification element F can be an ATM card, a debit card or a credit card, so that it can be used not only to identify the user but also to purchase the ticket order.

The ordering process P02 provides one or more ticket-ordering interfaces for the user so as to create electronic ticket information, provides an input interface for the user to input electronic communication data, and deducts money from an account corresponding to the financial identification element.

The ticket-ordering interface or the input interface can be displayed on a display module of the automatic teller apparatus. The user may operate an input module of the automatic teller apparatus, such as a key pad or touch panel, to select the desired ticket or input the electronic communication data.

The electronic ticket information D1 includes, for example, ticket type data and price data, so that the ordering process deducts money from the account corresponding to the financial identification element F according to the price data. In other words, the price data varies depending on the ticket type data, and the ordering process can deduct the money, which is the same as the price in the price data, from the account corresponding to the financial identification element F. Of course, if the financial identification element F is a credit card, the ordering process can deduct the money from the available credit of the credit card according to the price data. The deducted money will be transmitted to a receiving account later.

The ticket type data may include a location column, a name column, a time column, an origin-destination column, a seat column, a vehicle type column, or their combinations.

The communicating process P03 transmits the electronic ticket information and the electronic communication data to an external server.

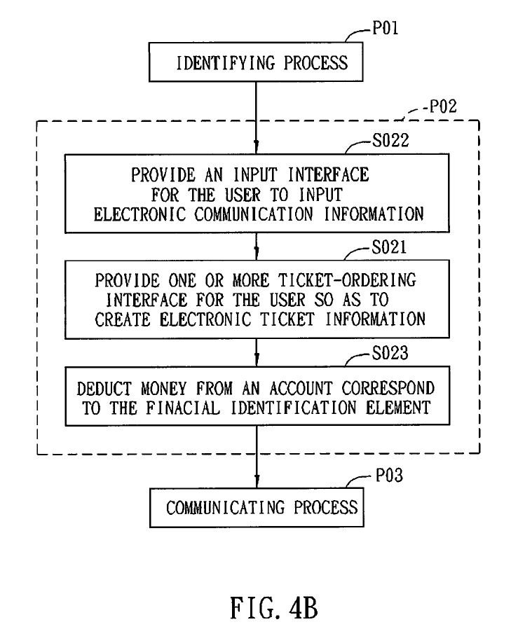

With reference to FIGS. 4A and 4B, the ordering process P02 includes steps S021 to 5023, and the order of the steps 5021 to S023 can be changed. As shown in FIG. 4A, the step S021 is to provide one or more ticket-ordering interfaces for the user, so that the electronic ticket information can be created after the user operates the ticket-ordering interface. Then, the step S022 is to provide an input interface for the user to input electronic communication data. After that, the step 5023 is to deduct money from an account corresponding to the financial identification element, and the deducted money is transmitted to a receiving account later.

Alternatively, as shown in FIG. 4B, the ordering process P02 includes the step 5022, the step 5021 and the step S023 in order. In addition, the ordering process P02 may include the step 5021, the step 5023 and the step S022 in order. Of course, other orders of the steps S021 to S023 are also possible.

In addition, the ordering process P02 may further include a balance checking step for checking whether the account corresponding to the financial identification element contains enough money for the deduction. For example, the balance checking step may be performed before the step S023 and after the step S021.

According to the above-mentioned steps, the use can order the ticket through the automatic teller apparatus, so it becomes more convenient for the user to buy the ticket because the automatic teller apparatuses are available at many places. The more detailed implementation will be described in the following embodiments.

The following descriptions are several examples to implement the ticket order processing method used in the automatic teller apparatus to order different tickets.

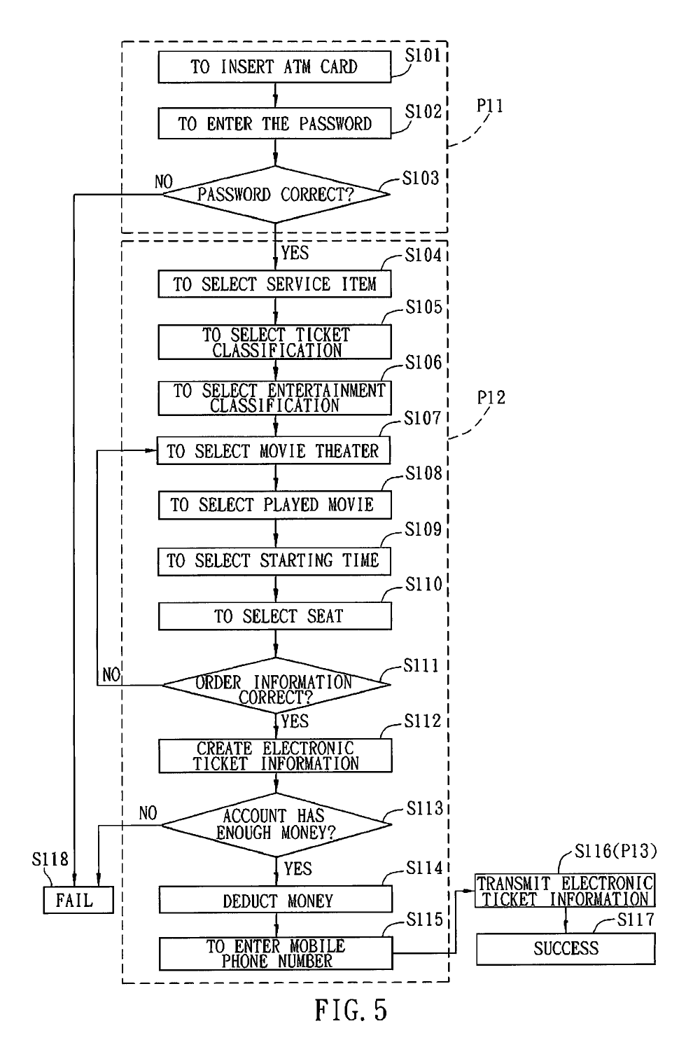

With reference to FIG. 5, the ticket order processing method includes an identifying process P11, an ordering process P12 and a communicating process P13, and the following example is to order a movie ticket.

The identifying process P11 includes steps S101 to S103. The step S101 is to instruct the user to insert his/her ATM card, and then the user follows the instruction and inserts the ATM card into the automatic teller apparatus.

The step S102 is to instruct the user to enter the password, and then the user operates the key pad or touch panel of the automatic teller apparatus to enter the password of the ATM card.

The step S103 is to determine whether the entered password is correct or not. If it is incorrect, the step S118 is performed; otherwise, if it is correct, the step S104 is performed.

In the above steps S101 to S103, the financial identification element is an ATM card for example. Of course, the financial identification element can also be different cards such as a credit card or a RF ID card.

The ordering process P12 includes steps S104 to S115.

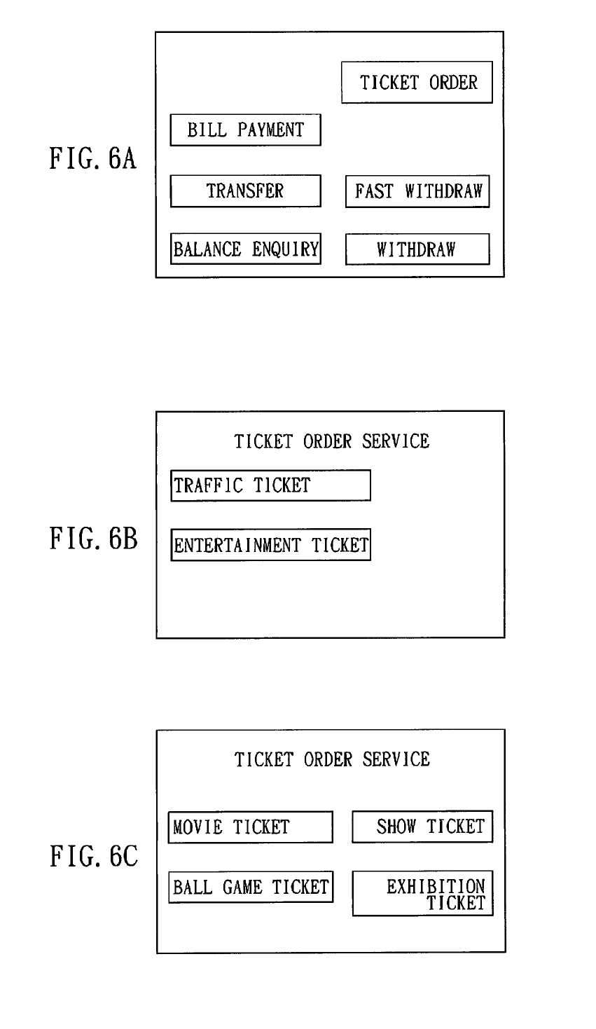

The step S104 is to prompt the user to select one of the service items as shown in FIG. 6A. The display module of the automatic teller apparatus shows the available service items such as ticket order, bill payment, transfer, balance enquiry, fast withdraw, withdraw, etc. Accordingly, the user can operate the input interface of the automatic teller apparatus to select the needed service item.

The following description illustrates the case that the user selects the ticket order item to order a movie ticket, and the examples for selecting other service items are not discussed hereinbelow.

The step S105 is to prompt the user to select one of the ticket classifications of the available tickets as shown in FIG. 6B. The display module of the automatic teller apparatus shows the ticket classifications, which includes “Traffic Ticket”, “Entertainment Ticket”, etc. In this case, since the user wants to order a movie ticket, he/she selects the “Entertainment Ticket” item through the input module.

The step S106 is to prompt the user to select one of the entertainment classifications as shown in FIG. 6C. The display module of the automatic teller apparatus shows the available entertainment classifications, which includes “Movie Ticket”, “Show Ticket”, “Ball Game Ticket”, “Exhibition Ticket”, etc. In this case, the user selects the “Movie Ticket” item through the input module.

The step S107 is to prompt the user to select one of the movie theaters. The display module of the automatic teller apparatus shows the name of at least one movie theater, and the user selects the desired movie theater through the input module.

The step S108 is to prompt the user to select one of the played movies. In this case, the display module of the automatic teller apparatus shows the name of at least one movie, and the user selects the desired movie through the input module.

The step S109 is to prompt the user to select the starting time of the selected movie. In this case, the display module of the automatic teller apparatus shows the starting time of the selected movie on the movie schedule, and the user selects the suitable starting time of the movie through the input module.

The step S110 is to prompt the user to select one of the seats. In this case, the display module of the automatic teller apparatus shows the seat chart, and the user selects the suitable seats through the input module.

The step S111 is to prompt the user to confirm whether the order information is correct or not. In this case, the display module of the automatic teller apparatus displays all selected or inputted information in the steps S107 to S110. If the user clicks the “Confirm” button, the step S112 is then performed; otherwise, if the user clicks the “Change” button, then the user is asked to indicate which information is incorrect and to correct the information through the corresponding steps S107 to S110.

The step S112 is to create the electronic ticket information, which includes the ticket type data and the price data, according to the confirmed information in the step S111. For example, the ticket type data are established according to the selected items or inputted data in the steps S107 to S110, and the price data are established according to the price for the ordered ticket(s).

The step S113 is to check whether the account corresponding to the ATM card has enough money or not. If yes, the step S114 is then performed; otherwise, if no, the step S118 is then performed.

The step S114 is to deduct money from the account corresponding to the ATM card according to the price data in the electronic ticket information, and the deducted money will be transferred to a receiving account later.

The step S115 is to prompt the user to enter his/her mobile phone number as shown in FIG. 6D. In this case, the user can operate the input module to enter his/her mobile phone number.

The communicating process P13 includes the step S116.

The step S116 is to transmit the electronic ticket information, which includes the ticket type data and the price data, and the mobile phone number to the external server, so that the external server can transmit the electronic ticket to the mobile phone corresponding to the phone number.

The step S117 is to prompt the user that the transaction is success, and the automatic teller apparatus ejects the ATM card. In this case, the display module of the automatic teller apparatus shows the result of the successful transaction, and the result of the successful transaction can also be printed out.

The step S118 is to prompt the user that the transaction is failed, and the automatic teller apparatus also ejects the ATM card. In this case, the display module of the automatic teller apparatus shows the result of the failed transaction, and the result of the failed transaction can also be printed out.

In the present embodiment, the order of the above-mentioned steps can be changed. For example, the step S107 for selecting the movie theater and the step S108 for selecting the movie can be combined, the step S109 for selecting the starting time of the movie and the step S110 for selecting the seat can be combined, or the step S108 may prior to the step S107. Alternatively, the user may select the desired ticket before inserting the ATM card (step S101). That is, the steps S104 to S111 may be performed in advance, and then the steps S101 to S103 are performed.

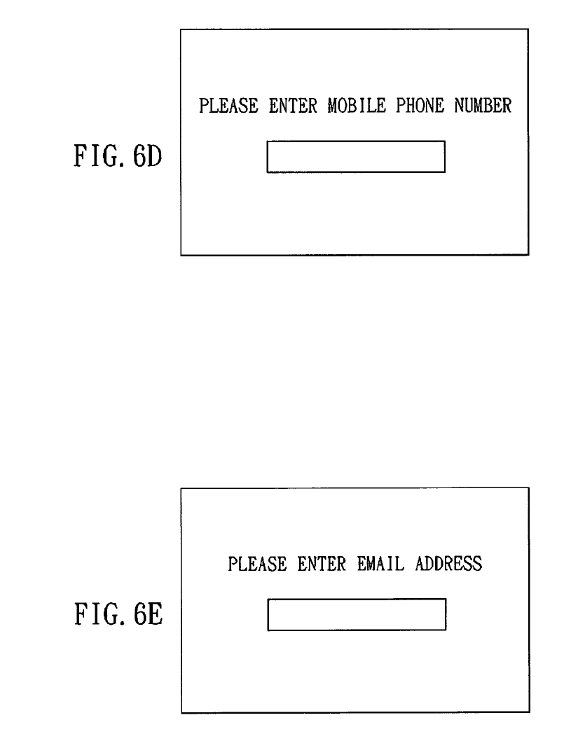

With reference to FIG. 7, the ticket order processing method includes an identifying process P21, an ordering process P22 and a communicating process P23, and the following example is to order a train ticket.

The identifying process P21 includes steps S201 to S203.

The step S201 for instructing the user to insert his/her ATM card and the step S202 for instructing the user to enter the password are the same as the steps S101 and S102 in FIG. 4, so the detailed description thereof will be omitted.

The step S203 is to determine whether the entered password is correct or not. If it is incorrect, the step S218 is performed; otherwise, if it is correct, the step S204 is performed.

The ordering process P22 includes steps S204 to S215.

The step S204 is to prompt the user to select one of the service items as shown in FIG. 6A. The display module of the automatic teller apparatus shows the available service items such as ticket order, bill payment, transfer, balance enquiry, fast withdraw, withdraw, etc. Accordingly, the user can operate the input interface of the automatic teller apparatus to select the needed service item.

The following description illustrates the case that the user selects the ticket order item to order a train ticket, and the examples for selecting other service items are not discussed hereinbelow.

The step S205 is to prompt the user to select one of the ticket classifications of the available tickets as shown in FIG. 6B. The display module of the automatic teller apparatus shows the ticket classifications, which includes “Traffic Ticket”, “Entertainment Ticket”, etc. In this case, since the user wants to order a train ticket, he/she selects the “Traffic Ticket” item through the input module.

The step S206 is to prompt the user to select one of the traffic classifications. The display module of the automatic teller apparatus shows the available traffic classifications, which includes “Train Ticket”, “Bus Ticket”, “Cruise Ticket”, etc. In this case, the user selects the “Train Ticket” item through the input module.

The step S207 is to prompt the user to select the departure train station. The display module of the automatic teller apparatus shows the name of at least one train station, and the user selects the desired departure train station through the input module.

The step S208 is to prompt the user to select the destination train station. In this case, the display module of the automatic teller apparatus shows the name of at least one train station, and the user selects the desired destination train station through the input module.

The step S209 is to prompt the user to select the departure time. In this case, the display module of the automatic teller apparatus shows the available train schedule, and the user selects the suitable departure time through the input module.

The step S210 is to prompt the user to select one of the seats. In this case, the display module of the automatic teller apparatus shows the seat chart, and the user selects the suitable seats through the input module.

The step S211 is to prompt the user to confirm whether the order information is correct or not. In this case, the display module of the automatic teller apparatus displays all selected or inputted information in the steps S207 to 5210. If the user clicks the “Confirm” button, the step S212 is then performed; otherwise, if the user clicks the “Change” button, then the user is asked to indicate which information is incorrect and to correct the information through the corresponding steps S207 to S210.

The step S212 is to create the electronic ticket information, which includes the ticket type data and the price data, according to the confirmed information in the step S211. For example, the ticket type data are established according to the selected items or inputted data in the steps S207 to S210, and the price data are established according to the price for the ordered ticket(s).

The step S213 is to check whether the account corresponding to the ATM card has enough money or not. If yes, the step S214 is then performed; otherwise, if no, the step S218 is then performed.

The step S214 is to deduct money from the account corresponding to the ATM card according to the price data in the electronic ticket information, and the deducted money will be transferred to a receiving account later.

The step S215 is to prompt the user to enter his/her email address as shown in FIG. 6E. In this case, the user can operate the input module to enter his/her email address.

The communicating process P23 includes the step S216.

The step S216 is to transmit the electronic ticket information, which includes the ticket type data and the price data, and the email address to the external server, so that the external server can transmit the electronic ticket to the email box corresponding to the email address.

The step S217 is to prompt the user that the transaction is success, and the automatic teller apparatus ejects the ATM card. In this case, the display module of the automatic teller apparatus shows the result of the successful transaction, and the result of the successful transaction can also be printed out.

The step S218 is to prompt the user that the transaction is failed, and the automatic teller apparatus also ejects the ATM card. In this case, the display module of the automatic teller apparatus shows the result of the failed transaction, and the result of the failed transaction can also be printed out.

In the present embodiment, the order of the above-mentioned steps can be changed. For example, the step S207 for selecting the departure train station and the step S208 for selecting the destination train station can be combined, the step S209 for selecting the departure time and the step S210 for selecting the seat can be combined, or the step S209 may prior to the step S208. Alternatively, the user may select the desired ticket before inserting the ATM card (step S201). That is, the steps S204 to S211 may be performed in advance, and then the steps S201 to S203 are performed.

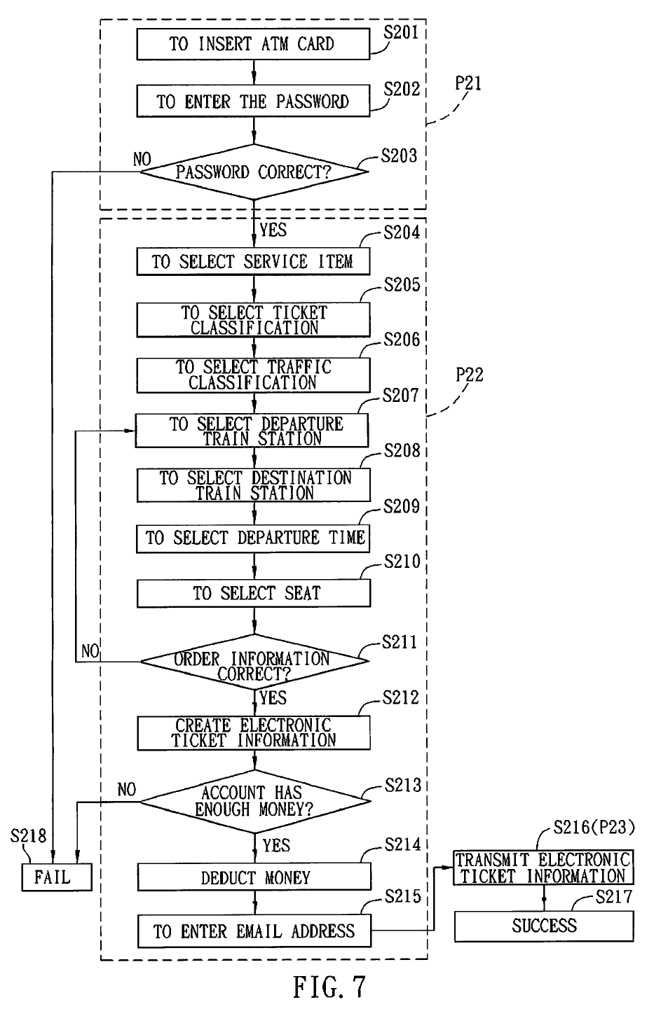

Referring to FIG. 8, an automatic teller apparatus 1 includes an identification module 11, an ordering module 12 and a communicating module 13.

The identification module 11 identifies a user according to a financial identification element F. In other words, the identification module 11 reads the financial identification element F to retrieve the account information of the user through the bank server 2 so as to identify the user.

The ordering module 12 provides one or more ticket-ordering interfaces for the user to create electronic ticket information D1. In addition, the ordering module 12 also provides an input interface for the user to input electronic communication data D2. Then, the ordering module 12 further deducts money from an account corresponding to the financial identification element F.

The communicating module 13 transmits the electronic ticket information D1 and the electronic communication data D2 to an external server 2. Alternatively, the communication module 13 can transmit the electronic ticket information D1 and the electronic communication data D2 to the external server 2 through the bank server 2 as shown in FIG. 2.

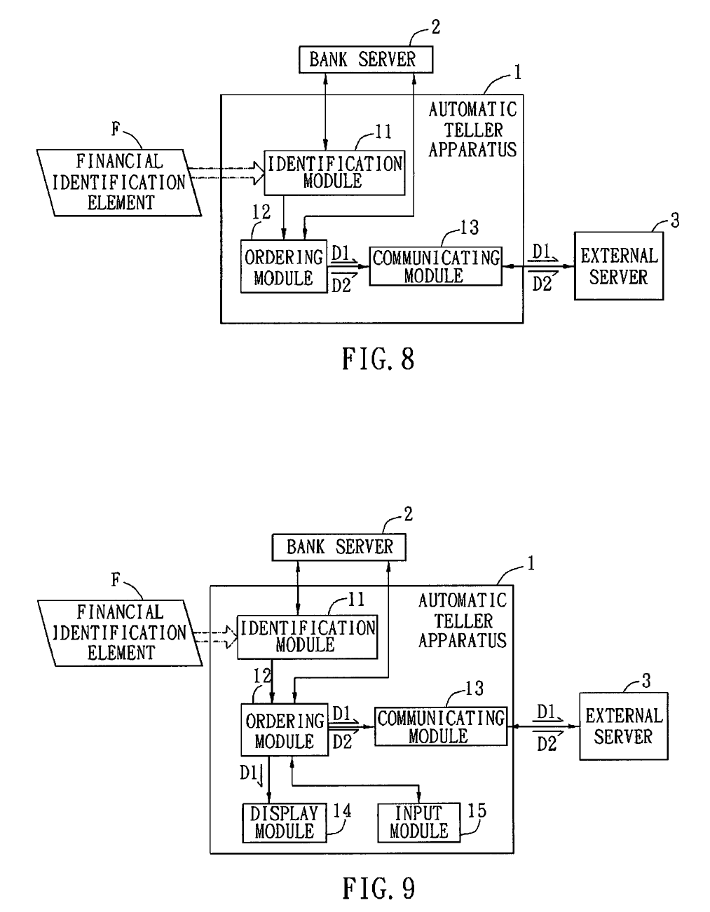

As shown in FIG. 9, the automatic teller apparatus 1 further includes a display module 14 (e.g. a monitor or a touch panel) and an input module 15 (e.g. a key pad).

Accordingly, when the user inserts the financial identification element F (e.g. an ATM card) into the automatic teller apparatus 1, the identifying module 11 can read the financial identification element F to retrieve the account information of the user through the bank server 2 so as to identify the user. Then, when the user selects the ticket order function provided by the automatic teller apparatus 1, the ordering module 12 can link to the external server 3 and the display module 14 shows a ticket ordering interface, which can be controlled through a touch panel or a key pad. Therefore, the user can follow the instructions to operate the ordering procedures.

After the user finishes the ordering procedures, the ordering module 12 can deducts money from an account corresponding to the financial identification element F according to the price data in the electronic ticket information D1. Then, the deducted money is transmitted to a receiving account. In addition, the ordering module 12 further provides an input interface for the user to input the electronic communication data D2. Then, the communicating module 13 transmits the electronic ticket information D1 and the electronic communication data D2 to the external server 3, so that the external server 3 can transmit the electronic ticket to a portable electronic device, such as a mobile phone, a notebook computer or the desktop computer, corresponding to the electronic communication data D2.

In the embodiments of FIGS. 8 and 9, the identifying module 11 may include a bar code scanner or an RFID reader for identifying the financial identification element F. The ordering module 12 may include a processor and a memory, so that the processor can execute the instructions of the memory and then process the data stored in the memory. The communicating module 13 may include a network communication element for communicating with other apparatuses.

Since the automatic teller apparatuses 1 are available everywhere, so that the user can buy various kind of tickets more convenient. In addition, since the ticket order is performed through the automatic teller apparatuses 1, the personal information may not be stolen, and the money for the ticket can be directly deducted from the account corresponding to the financial identification element F. This further enhances the convenience for the user to order the tickets through the automatic teller apparatuses 1. Moreover, the user may input electronic communication data D2, such as his/her mobile phone number or email address, through the automatic teller apparatuses 1, so that the electronic ticket can be transmitted to the mobile phone or email box of the user. Then, the user can use the received electronic ticket directly, thereby greatly enhancing the convenience of ordering tickets.

Alternatively, the automatic teller apparatus 1 of FIG. 8 or 9 may be linked to the external server 3 through the bank server 2 as described in FIGS. 2A and 2B. Thus, the automatic teller apparatus 1 can transmit the electronic ticket information D1 and the electronic communication data D2 to the external server 3 through the bank server 2. In addition, the contents of the available tickets, which can be sold through the automatic teller apparatus 1, are provided by the external server 3 or the bank server 2.

In summary, the present invention utilizes the automatic teller apparatuses, which are available everywhere, to solve the inconvenience for the user to buy various kind of tickets. In addition, since the ticket order is performed through the automatic teller apparatuses, the personal information may not be stolen, and the money for the ticket can be directly deducted from the account corresponding to the financial identification element. This further enhances the convenience for the user to order the tickets through automatic teller apparatuses. Moreover, according to the present invention, the user may input electronic communication data, such as his/her mobile phone number or email address, so that the electronic ticket can be transmitted to the mobile phone or email box of the user. Then, the user can use the received electronic ticket directly, thereby greatly enhancing the convenience of ordering tickets.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A ticket order processing method used in an automatic teller apparatus, comprising:
an identifying process for identifying a user according to a financial identification element;
an ordering process for providing one or more ticket-ordering interfaces for the user so as to create electronic ticket information, providing an input interface for the user to input electronic communication data, and deducting money from an account corresponding to the financial identification element; and
a communicating process for transmitting the electronic ticket information and the electronic communication data to an external server.

2. The method according to claim 1, wherein the external server creates an electronic ticket according to the electronic ticket information and then transmits the electronic ticket to a portable electronic device according to the electronic communication data.

3. The method according to claim 2, wherein the electronic ticket is a traffic ticket or an entertainment ticket.

4. The method according to claim 2, wherein the electronic ticket comprises a two-dimensional code bar according to the electronic ticket information.

5. The method according to claim 2, wherein the electronic ticket information comprises ticket type data and price data, and the ordering process deducts money from the account corresponding to the financial identification element according to the price data.

6. The method according to claim 5, wherein the ticket type data comprises a location column, a name column, a time column, an origin-destination column, a seat column, a vehicle type column, or their combinations.

7. The method according to claim 1, wherein the financial identification element is an ATM card, a debit card or a credit card.

8. The method according to claim 1, wherein the electronic communication data is a mobile phone number or an e-mail address.

9. An automatic teller apparatus, comprising:
an identification module identifying a user according to a financial identification element;
an ordering module providing one or more ticket-ordering interfaces for the user to create electronic ticket information, providing an input interface for the user to input electronic communication data, and deducting money from an account corresponding to the financial identification element; and
a communicating module transmitting the electronic ticket information and the electronic communication data to an external server.

10. The automatic teller apparatus according to claim 9, wherein the external server creates an electronic ticket according to the electronic ticket information and then transmits the electronic ticket to a portable electronic device according to the electronic communication data.

11. The automatic teller apparatus according to claim 10, wherein the electronic ticket is a traffic ticket or an entertainment ticket.

12. The automatic teller apparatus according to claim 10, wherein the electronic ticket comprises a two-dimensional code bar according to the electronic ticket information.

13. The automatic teller apparatus according to claim 10, wherein the electronic ticket information comprises ticket type data and price data, and the ordering module deducts money from the account corresponding to the financial identification element according to the price data.

14. The automatic teller apparatus according to claim 13, wherein the ticket type data comprises a location column, a name column, a time column, an origin-destination column, a seat column, a vehicle type column, or their combinations.

15. The automatic teller apparatus according to claim 9, wherein the financial identification element is an ATM card, a debit card or a credit card.

16. The automatic teller apparatus according to claim 9, wherein the electronic communication data is a mobile phone number or an e-mail address.
